(19) United States
(12) Patent Application Publication
(10) Pub. No.: US 2008/0209393 A1
(43) Pub. Date: Aug. 28, 2008

(54) System and method to automatically detect incompatible licensing models

(76) Inventors: Tomas Evensen, Foster City, CA (US); Felix Burton, San Mateo, CA (US)

Correspondence Address: FAY KAPLUN & MARCIN, LLP, 150 BROADWAY, SUITE 702, NEW YORK, NY, 10038, US

(21) Appl. No.: 11/712,880

(22) Filed: Feb. 28, 2007

(51) Int. Cl. G06F 9/44

(52) U.S. Cl. 717/108

(57) ABSTRACT

A system and method for inserting a marker in an object file, the marker indicating that at least a portion of the object file is subject to a first license agreement, determining if the first license agreement of the object file and a second license agreement to which one of the object file and a further object file to which the object file is linked are incompatible and when the first license agreement and the second license agreement are incompatible, displaying an error message to a user.

### BACKGROUND

With improvements in network capabilities and the World Wide Web, intellectual property protection has become a big issue. To avoid restrictions on certain intellectual property, viral licenses (e.g., copyleft, open source licenses) are sometimes used to prevent restrictions otherwise provided by copyrights. Viral licenses such as the General Public License (GPL) allow users to use, modify, distribute, and improve source code but do not allow the users to maintain proprietary rights so that subsequent users are also allowed to use the source code fully. When a file that is under a viral license is linked to a file under a proprietary license, the viral license may “contaminate” the proprietary license and the file may be made available under the viral license (e.g., open source). Conventional build and link processes in complex software environments make it difficult to recognize if a viral license contaminates a proprietary license. Currently, a user individually prevents any contamination in an ad hoc manner, usually by trusting that developers will know which codes are linked with anything else or by running through the lines of source files.

### SUMMARY OF THE INVENTION

A method for inserting a marker in an object file, the marker indicating that at least a portion of the object file is subject to a first license agreement, determining if the first license agreement of the object file and a second license agreement to which one of the object file and a further object file to which the object file is linked are incompatible and when the first license agreement and the second license agreement are incompatible, displaying an error message to a user.

A system having a compiler receiving a first source file to output a corresponding first object file and receiving a second source file to output a corresponding second object file, the compiler inserting a first marker in the first object file and a second marker in the second object file and a linker receiving the first and second object files and determining if the first and second markers are incompatible, and when the markers are incompatible, displaying an error message to a user.

A system having a license list including indicators corresponding to a plurality of licenses and a marker module comparing indicators of the license list to a source file and inserting a marker corresponding to each matched indicator in an object file compiled from the source file.

### BRIEF DESCRIPTION OF THE DRAWINGS

FIG. 1 shows an exemplary embodiment of a system designed to automatically detect incompatible licensing models according to the present invention.

FIG. 2 shows an exemplary embodiment of a system of a linker from the system of FIG. 1 with inputs and outputs according to the present invention.

FIG. 3 shows an exemplary method to automatically detect incompatible licensing models according to the present invention.

### DETAILED DESCRIPTION

The present invention may be further understood with reference to the following description and the appended drawings, wherein like elements are referred to with the same reference numerals. The exemplary embodiments of the present invention describe a method to automatically detect incompatible licensing models. The method of the exemplary embodiments involves two main stages, a marking stage and a comparison stage. The licensing models and stages will be discussed in detail below. It should be noted that throughout this description, the term viral license, the term open source license, and the use of GPL will generally refer to an open source license. The exemplary embodiments will be described with reference to determining if an open source license and a proprietary license are in conflict in compiled code. However, those skilled in the art will understand that the present invention may be used to detect inconsistencies between any types of licenses to which coupled code may be subject.

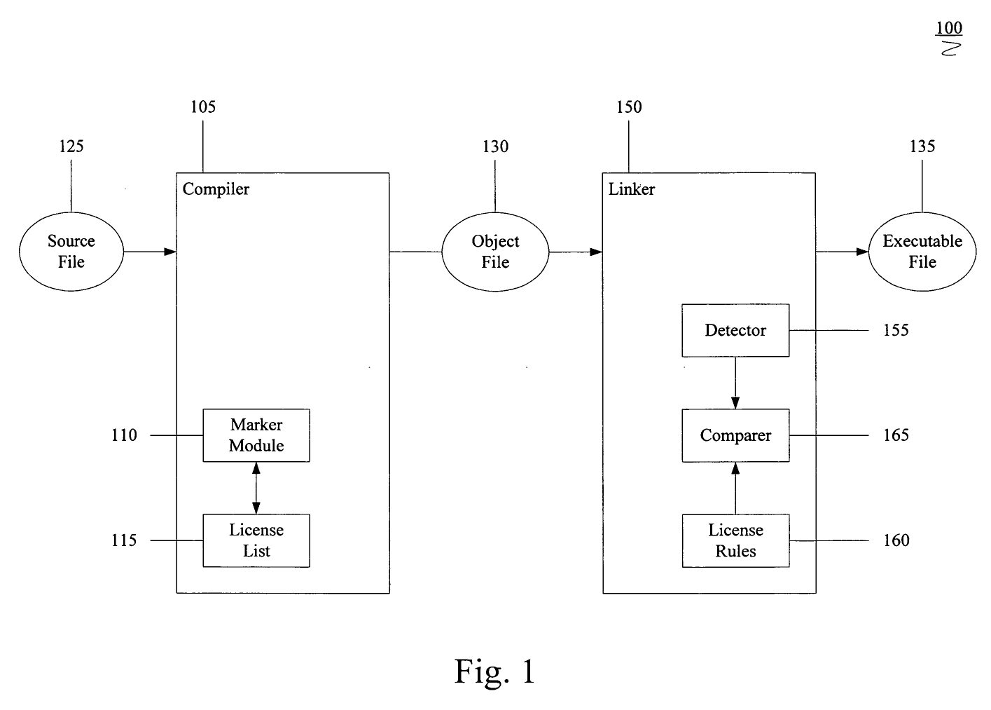

FIG. 1 shows an exemplary embodiment of a system 100 designed to automatically detect incompatible licensing models according to the present invention. The system 100 includes two main components, a compiler 105 and a linker 150. The compiler 105 further includes a marker module 110 and a license list 115. The linker 150 further includes a detector 155, license rules 160, and a comparer 165.

The compiler 105 is a computer program (or set of programs) that translates text written in a computer language (e.g., source language such as C, C++, Java, etc.) into another computer language (e.g., target language such as object code). The original sequence is usually referred to as a source file 125 and the output is usually referred to as an object file 130. Commonly, the object file has a form suitable for processing by other programs (e.g., linker 150). In the exemplary embodiment, the compiler 105 includes functionality to translate the source file 125 to include additional signals in the object file 130. Those skilled in the art will understand that a source file 125 will typically include multiple individual files and the term “source file” as used in this description may refer to the collective group of these files or a particular individual file.

The marker module 110 is an additional component or functionality of the compiler 105. The marker module 110 inserts a marker in the object file 130 that indicates the type of license(s) that covers the object file 130. The marker module 110 may do this in a variety of manners. For example, the marker module 110 may explicitly insert a marker (e.g., #pragma, #ident, etc.) in the object file 130. In another example, the marker module 110 may automatically insert a marker through a preprocessor. The preprocessor is modified to detect intellectual property rights (e.g., copyright notices) and places an appropriate marker in the object file 130. In a further example, the marker module may specify that all files in a certain directory are covered by the same license. In a still further exemplary embodiment, the marker module 110 may save an indication to a separate file (e.g., a database file) indicating the file name (and path) and the corresponding license for this file. It should be noted that the use of a separate component (e.g., marker module 110) is only exemplary. Those skilled in the art will understand that the compiler 105 may already contain the functionality to mark the source file 125 based on specified parameters. The functionality of the marker module 110 will be discussed in more detail below.

Those skilled in the art will understand that multiple licenses may be incorporated in a source file. For example, the source file may be a modified file that originated from a file containing a GPL license and a modification containing a proprietary license. The file may have been further improved upon by a subsequent user that included a Berkley Software Distribution (BSD) in the improvement. All prior licenses would remain with the source file 125 unless prior deletion or compensation (e.g., idling at least one of the licenses) occurred.

The license list 115 may be a database of potential licenses that may be incorporated within the source file 125. The license list 115 may include the complete licenses or may contain keywords, phrases or terms that indicate a particular type of license. The marker module 110 is connected to the license list 115 to determine the type of marker to insert in the object file 130. The marker module 110 may note which section or location within the source file 125 that is subject to the detected license. This may help the developer locate any incompatible licenses that are identified later in the process. The marker module 110 may use the license list 115 to note which specific license is covering the different sections of the source file 125. For example, the marker module 110 may include a first marker that states that a first section of the source file 125 is covered by GPL, a second marker that states that a second section of the source file 125 is covered by a specific proprietary license, etc. Such markings allow a user to prevent any contamination of desired proprietary licenses by viral licenses. The license list 115, the marker module 110, and their functionalities will be discussed in more detail below.

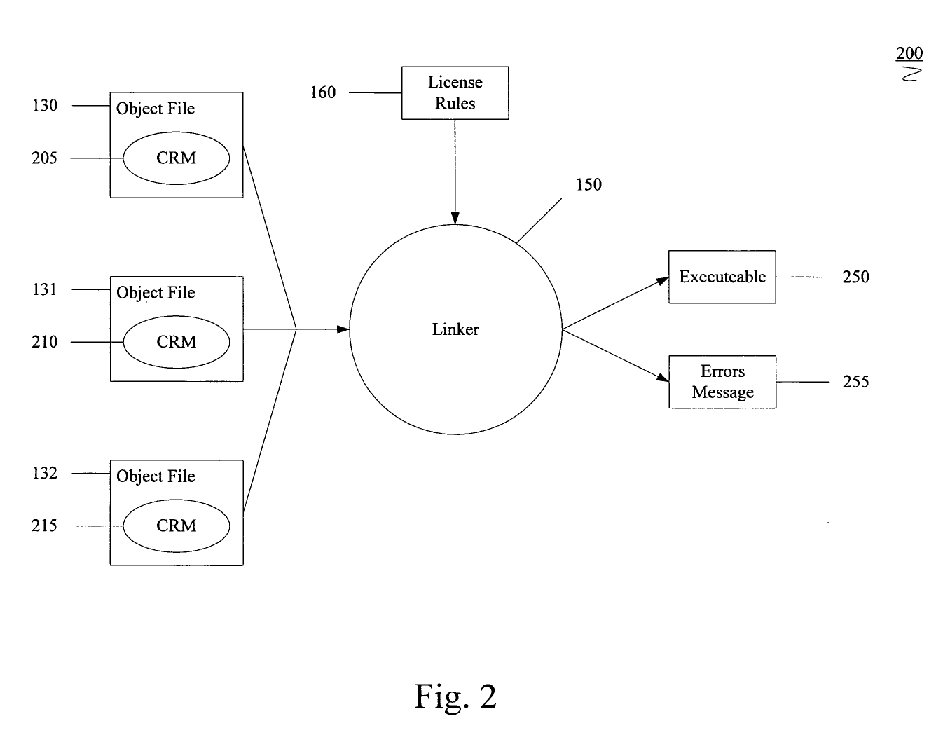

The linker 150 is a program that takes one or more objects (e.g., object file 130) generated by compilers (e.g., compiler 105) and merges them into a single executable program. The objects may be program modules containing machine code and information for the linker 150. The information comes from symbol definitions, in two main forms. The first form is defined or exported which are functions or variables that are present in the module represented by the object and usually available for use by other modules. The other form is undefined or imported which are functions or variables that are called or referenced by the object and may not be internally defined. It should be noted that either form of symbol definition is possible to be utilized in the present invention. The overall process occurring at the linker 150 will be described in more detail below with reference to FIG. 2.

The detector 155 is an additional component or module of the linker 150. The detector 155 locates any marker inserted by the marker module 110 in the object file 130 that is inputted into the linker 150, prior to linking the objects. Depending on the form of marker that is inserted (as discussed above), the detector 155 may compile a list of the licenses that are present in the object file 130 and sends the list to the comparer 165. The comparer 165 is connected to license rules 160. The license rules 160 is a database that informs the comparer whether a certain pairing of licenses would create a conflict (i.e., the licenses are incompatible). For example, the license rules 160 may contain data that an object with a GPL license and an object with a proprietary license are not allowed to be linked by the linker 150. In another example, if the marker module 110 inserts a marker noting that a license is either proprietary or viral, the license rules 160 may contain a single rule (e.g., proprietary license object is not allowed to be linked with a viral license object). Thus, if the detector 155 finds that there is at least one proprietary license and at least one viral license, the linker 150 will know to take subsequent action before execution. It should be noted that the use of a separate component (e.g., detector 155) is only exemplary. Those skilled in the art will understand that the linker 150 may already contain the functionality to read any licenses inserted by the marker module 110 of the compiler 105 that are present in the object file 130. Those skilled in the art will also understand that it is possible that the detector 155, license rules 160 and comparer 165 may be implemented as a separate program that runs on the executable file after the linker 150 has performed the linking operation. In such an example, the detector 155/license rules 160/comparer 165 may be thought of as a post-processing element for executable files.

The comparer 165 is an additional component or module of the linker 150. The comparer 165 reads the information from the detector (e.g., types of licenses in object file 130). The comparer 165 may also mix and match each license type by pairing them together and then comparing the results with the data contained in the license rules 160. Once all comparisons are made, the comparer 165 determines if the linker 150 is allowed to link the object file 130 with any other objects that were inputted into the linker 150.

FIG. 2 shows an exemplary embodiment of a system 200 of the linker 150 from the system of FIG. 1 with inputs and outputs according to the present invention. FIG. 1 described a single object file that is inputted into the linker 150. However, as described above, the linker 150 takes one or more objects and assembles them into a single executable file 135. It is implied in the present invention that at least two object files 130-132 are inputted into the linker 150 since a comparison is made to the license types contained in the object files 130-132. Thus, the inputs to the linker 150 of FIG. 2 include object files 130-132 with copyright markers (CRM) 205-215, respectively. The outputs of the linker 150 of FIG. 2 include an executable file 250 or an errors message 255.

In the exemplary embodiment of the system 200, the linker 150 receives three object files 130-132. It should be noted that there may be less or more object files inputted in the linker 150. As discussed above, the object files 130-132 include the CRMs 205-215, respectively, from the marker module 110 of the compiler 105. Each object file 130-132 may have been produced from a single compiler 105 or may have been produced from an individual compiler creating each object file. The CRMs 205-215 may be identical or may be different from each other. For example, the CRMS 205-215 may all be GPL. In another example, the CRM 205 may be a GPL, the CRM 210 may be a BSD, and the CRM 215 may be a proprietary license.

FIG. 2 illustrates that the license rules 160 are also inputted into the linker 150. Those skilled in the art will understand that the license rules 160 may be part of the linker 150 as illustrated in FIG. 1 or may be a separate database that is accessed (e.g., inputted) into the linker 150 when needed as illustrated in FIG. 2. As discussed above, the linker 150 runs a comparison with the CRMs 205-215 and if the linker 150 determines that no licensing incompatabilities exist, the linker 150 performs conventional linking techniques and an executable file 250 is generated from linking the object files 130-132. However, if a conflict is found between any two CRMs 205-215, an error message is generated. In the event of a conflict, the user may configure the linker 150 to only generate the error message 255 or both the error message 155 and the executable 250.

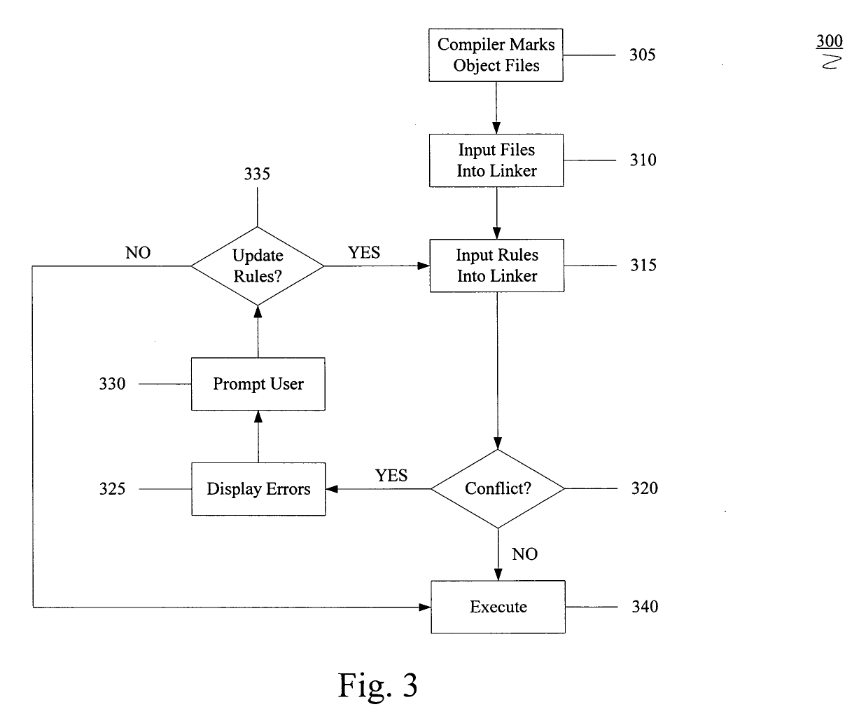

FIG. 3 shows an exemplary method 300 to automatically detect incompatible licensing models according to the present invention. The method 300 will be described with reference to the components of FIGS. 1-2. The method 300 begins at step 305 when the compiler 105 inserts markers in the object files 130-132 using the marker module 110. As described above, the markers that are inserted are based on the license list 115. Once the object files have been properly marked with the appropriate licensing markers, the compiler 105 produces the object files 130-132 which are inputted into the linker 150 at step 310. At step 315, the license rules 160 are inputted into the linker 150. It should again be noted that step 315 may not be necessary as the license rules 160 may already be a part of the linker 150.

After the linker 150 receives the object files 130-132 and the license rules 160, the linker 150 determines if a conflict exists between any pairing of the CRMs 205-215 at step 320. As discussed above, the linker 150 uses the detector 155 to determine the type of CRM that is contained in each object file and uses the comparer 165 to base a comparison between each pairing of CRMs against the license rules 160. If no conflict is detected at step 320, the method 300 continues to step 340 where an executable file 135 is generated.

If a conflict is detected at step 320, the method continues to step 325 where the conflicts (i.e., errors) are displayed for the user using the errors message 255. The method 300 may conclude upon displaying the errors message 255 so that the user may adjust any licenses or prevent any contamination before continuing. However, the method 300 may also continue to step 330 where the linker 150 prompts the user with several options. One option is illustrated in step 335 where a prompt is given to a user to update the license rules 160. The user may choose to update the license rules 160 to include a conflicted pair of licenses to be allowable, etc. The rule update step 335 also allows a user to be notified if an object file does not contain a marker or contains a marker that notes there is an absence of a license type. In such a case, a user may have, for example, created a derivative work that the user wishes to place a proprietary license but inadvertently did not. Step 335, therefore, may serve as a check to verify the user is satisfied with the current condition of the linking of object files 130-132. The license rules 160 may contain a rule that states that in the absence of a license type, the method would automatically continue to step 325 where an error message is displayed. If the user chooses to update the rules at step 335, the method returns to step 315. If the user chooses not to update the rules at step 335, the method 300 may continue to step 340, where the executable file 135 is generated upon approval by the user despite the existence of conflicts.

It should be noted that the use of the prompt is only exemplary. As discussed above, the prompt is not necessary and the method 300 may be accomplished with only a display of the error message 255. Those skilled in the art will also understand that there may be additional prompts. For example, there may be a prompt that asks the user if the method 300 should continue to generate the executable file 135 despite a conflict between CRMs existing. This prompt would allow a user to bypass the license rules 160 that are imposed on the linker 150.

In another example, there may be a prompt that asks if a license should be added or removed. In such an embodiment, the linker 150 would include functionality that may manipulate the object files 130-132. However, it may be necessary to send the object files 130-132 back to the compiler 105 or another program that controls the assignment of license types. Those skilled in the art will understand that the linker 150 may indirectly manipulate the license assignments of object files 130-132 by calling the appropriate program and automatically making the changes that the user inputs.

Referring back to FIG. 1, the following description will further describe exemplary embodiments of the marker module 110, the license list 115, their combined functionalities, and potential outcomes (e.g., effect on the license rules 160). It should be noted that the following exemplary embodiments may be implemented in any combination and would still allow the present invention to achieve its purpose.

The first set of exemplary embodiments describes several different ways the license list 115 may be provided. In one exemplary embodiment, the license list 115 may be pre-loaded into the compiler 105. For example, the developer of the compiler 105 may create the license list 115. Thereafter, the marker module 110 may refer to the pre-loaded license list 115 to insert the appropriate marker on the object file 130. In a second exemplary embodiment, the license list 115 may be loaded by a user. For example, the user may create the license list 115 and incorporate it into the compiler 105 so that the appropriate license may be inserted in the object file 130 by the marker module 110. In a third exemplary embodiment, the license list 115 may be interactive or a learning program. For example, the license list 115 may include a set of rules to determine an appropriate license associated with the source file 125. Furthermore, if the license list 115 does not contain a set of rules for an unknown license, the compiler 105 or the marker module 110 may prompt the user to provide further information to determine the unknown license. The license list 115 may also be programmed so that it may learn and update itself with further information that is provided from encountering unknown licenses. The license list 115 may then identify the unknown license when it is later encountered. The license list 115 may also learn to identify other unknown licenses if they correspond to the updated set of rules for determining licenses.

The second set of exemplary embodiments describes several different ways the marker module 110 may insert a marker denoting the type of license using the license list 115. As discussed above, in the first exemplary embodiment, the marker module 110 may mark licenses based on proprietary and viral. For example, any form of proprietary license (e.g., Wind River, Sun, Microsoft, etc.) is labeled proprietary. Any form of viral license (e.g., GPL, etc.) is labeled viral. Thus, whenever a license is associated with the source file 125, the marker module 110 assigns, for example, a first marker for proprietary or a second marker for viral. Subsequently, the license rules 160 of the linker 150 may be simplified to determine that if both the first marker and the second marker are present, a conflict exists.

In a second exemplary embodiment, the marker module 110 may insert markers using the license list 115 based on the exact license present in the source file 125. For example, a source file 125 originating from Wind River would be marked with a first marker that denotes that a Wind River proprietary license exists. A source file 125 originating from Red Hat may be marked with a second marker that denotes that a BSD license exists. Thus, in this exemplary embodiment, there may be more than two license markers. Subsequently, the license rules 160 may be more complex since more than three possibilities (e.g., proprietary only, viral only, proprietary/viral combination) exist.

In a third exemplary embodiment, the marker module 110 may insert markers as a hybrid between the first two exemplary embodiments concerning insertion of markers described above. For example, with proprietary licenses that always create a conflict when paired with a viral license, the marker module 110 may insert a first marker in a first object file to denote proprietary. In the same manner, certain viral licenses may always create a conflict when paired with a proprietary license. Then the marker module 110 may insert a second marker in a second object file to denote viral. Other proprietary or viral licenses may allow a pairing with an opposite license (e.g., the developers have a prearranged agreement). These proprietary licenses may be marked with a specific marker denoting the exact license associated with that source file 125. The license rules 160 may include the necessary parameters involving these different types of licenses and their corresponding relationships amongst each other.

The third set of exemplary embodiments describes several different ways the license list 115 may include a set of rules to dictate how the marker module 110 inserts a marker in the object file 130. In one exemplary embodiment, the marker module 110 may scan each letter and/or word of the license. For example, the license list 115 may include a rule stating that a certain consecutive combination of terms indicate that the source file 125 is associated with a specific type of proprietary license. In a second example, the license list 115 may include a rule stating that the use of a specific term (e.g., company names, logos, etc.) automatically indicates that the source file 125 is associated a specific type of proprietary license. Upon scanning the license, the marker module 110 may insert the appropriate marker for the license on the object file 130. In another exemplary embodiment, the license list 115 may include a database of the actual licenses that are prevalent amongst source files. The marker module 110 may include functionality to compare the license associated with the source file 125 with the licenses contained in the license list 115. If a threshold percentage of terms overlap, then the marker module 110 may insert the appropriate marker for the type of license.

Those skilled in the art will also understand that the above described exemplary embodiments may be implemented in any number of manners, including, as a separate software module, as a combination of hardware and software, etc. For example, the marker module 105, the comparer 165, etc. may be a program containing lines of code that, when compiled, may be executed on a processor.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
inserting a marker in an object file, the marker indicating that at least a portion of the object file is subject to a first license agreement;
determining if the first license agreement of the object file and a second license agreement to which one of the object file and a further object file to which the object file is linked are incompatible; and
when the first license agreement and the second license agreement are incompatible, displaying an error message to a user.

2. The method of claim 1, wherein a further marker is included in the one of the object file and further object file indicating the second license agreement.

3. The method of claim 1, further comprising:
generating an executable file when the marker of the object file and the marker of the at least one other object file are compatible.

4. The method of claim 1, further comprising:
prompting the user to address the incompatibility.

5. The method of claim 1, wherein the object files are created by a compiler.

6. The method of claim 3, wherein the executable file is created by a linker.

7. The method of claim 1, wherein the marker indicates one of a specific type of a license.

8. The method of claim 7, wherein the type of license is one of a proprietary license and an open source license.

9. The method of claim 1, further comprising:
selecting the marker based on a comparison of the first license agreement to a license list.

10. The method of claim 1, wherein the determining includes comparing a plurality of rules related to the first and second licensing agreements.

11. A system, comprising:
a compiler receiving a first source file to output a corresponding first object file and receiving a second source file to output a corresponding second object file, the compiler inserting a first marker in the first object file and a second marker in the second object file; and
a linker receiving the first and second object files and determining if the first and second markers are incompatible, and
when the markers are incompatible, displaying an error message to a user.

12. The system of claim 11, wherein the first marker indicates a first license agreement and the second marker indicates a second license agreement.

13. The system of claim 11, wherein the linker generates an executable file when the first and second markers are compatible.

14. The system of claim 11, wherein the linker prompts the user to address the incompatibility.

15. The system of claim 12, wherein the first and second license agreements are one a proprietary license and an open source license.

16. The system of claim 12, wherein the compiler selects the first marker based on a comparison of the first license agreement to a license list and selects the second marker based on a comparison of the second license agreement to the license list.

17. The system of claim 12, wherein the determining includes comparing a plurality of rules related to the first and second licensing agreements.

18. A system, comprising:
a license list including indicators corresponding to a plurality of licenses; and
a marker module comparing indicators of the license list to a source file and inserting a marker corresponding to each matched indicator in an object file compiled from the source file.

19. The system of claim 18, further comprising:
a license rule list including rules defining relationships between the plurality of licensees;
a detector module detecting the markers in the object file; and
a comparer module comparing the markers to the rules,
where, if the rules indicate an incompatibility between markers, the comparer module generates an error message.

20. The system of claim 18, wherein the indicators are keywords.
